(19) United States
(12) Patent Application Publication
(10) Pub. No.: US 2014/0376122 A1
(43) Pub. Date: Dec. 25, 2014

(54) FLAT PANEL DISPLAY DEVICE AND METHOD OF MANUFACTURING THE SAME

(71) Applicant: SAMSUNG DISPLAY CO., LTD., YONGIN-CITY (KR)

(72) Inventors: YOUNG-IN LIM, CHEONAN-SI (KR); KYU-HO JUNG, OSAN-SI (KR); JUN-HO KWACK, Geumsan-gun (KR); SANG-HEE CHOI, NAM-GU (KR)

(73) Assignee: SAMSUNG DISPLAY CO., LTD., YONGIN-CITY (KR)

(21) Appl. No.: 14/286,719

(22) Filed: May 23, 2014

(30) Foreign Application Priority Data
Jun. 24, 2013 (KR) 10-2013-0072053

(51) Int. Cl. G02B 7/00; G02B 5/30

(52) U.S. Cl. CPC G02B 7/00; G02B 5/3025
USPC 359/893

(57) ABSTRACT

A flat panel display device includes a window, a mold, a black matrix, a display panel and a resin layer. The window has a connecting part and a transmission part through which light may pass. The mold is coupled to the connecting part of the window. The black matrix is disposed under the connecting part of the window, and the black matrix blocks light which is leaked from the mold. The display panel is disposed under the window. The display panel includes a first substrate and a second substrate, which is disposed opposite to the first substrate. The display panel further includes a polarizer which is disposed on the first substrate. The resin layer is disposed between the window and the display panel, and the resin layer is hardened by ultraviolet ray.

### CROSS-REFERENCE TO RELATED APPLICATION

This application claims priority under 35 U.S.C. §119 to Korean Patent Application No. 10-2013-0072053, filed on Jun. 24, 2013, in the Korean Intellectual Property Office (KIPO), the disclosure of which is incorporated by reference herein in its entirety.

### 1. TECHNICAL FIELD

The present disclosure relates to a flat panel display device, and more particularly to a method of manufacturing the flat panel display device.

### 2. DISCUSSION OF RELATED ART

A flat panel display device is a display element which displays an image by controlling light. The flat panel display is used in various electronic devices and various industrial fields due to its various features such as being lightweight, having compact size, and offering high resolution, large screen size, and low power consumption. Flat panel display devices may be characterized as a liquid crystal display device (LCD), a plasma display panel (PDP) and an organic light emitting diode display (OLED) based on a type of display panel of the flat panel display device.

In order to manufacture the flat panel display device, a process for laminating a display panel and a window is performed. In the laminating process, a resin is interposed between the display panel and the window, and the resin is hardened by ultraviolet light.

For example, a structure of glass in mold (GIM) has been used to decrease a thickness of the flat panel display device and to increase the durability of the flat panel display device. However, in the structure of the glass in mold, a resin layer might not be completely hardened because ultraviolet rays might not reach the resin layer.

### SUMMARY

Exemplary embodiments of the present invention provide a flat panel display capable of increasing a hardening ratio of a resin layer which bonds a display panel and a window.

Exemplary embodiments of the present invention provide a method of manufacturing a flat panel display capable of increasing a hardening ratio of a resin layer which bonds a display panel and a window.

According to exemplary embodiments of the present invention, a flat panel display device includes a window, a mold, a black matrix, a display panel and a resin layer. The window has a transmission part configured to transmit a light therethrough and a connecting part. The mold is coupled to the connecting part of the window. The black matrix is disposed under the connecting part of the window. The black matrix blocks light which is leaked from the mold. The display panel is disposed under the window, and the display panel includes a first substrate, a second substrate which is disposed opposite to the first substrate and a polarizer which is disposed on the first substrate. The resin layer is disposed between the window and the display panel, and the resin layer is hardened by ultraviolet ray.

According to exemplary embodiments of the present invention, the display panel may have a display area on which an image is displayed and a peripheral area which surrounds the display area.

According to exemplary embodiments of the present invention, the transmission part of the window may be disposed on the display area of the display panel, the connecting part of the window may be disposed on the peripheral area of the display panel, and the transmission part and the connecting part of the window may each have a stepped portion.

According to exemplary embodiments of the present invention, the mold may surround the peripheral area of the display panel.

According to exemplary embodiments of the present invention, the black matrix may be disposed under the connecting part of the window.

According to exemplary embodiments of the present invention, the black matrix may be disposed on the peripheral area of the display panel.

According to exemplary embodiments of the present invention, the resin layer, which is disposed on the display area of the display panel, may be hardened by the first ultraviolet light, which penetrates the transmission part of the window. The resin layer, which is disposed on the peripheral area of the display panel, may be hardened by the second ultraviolet light which is radiated from a back side of the display panel.

According to exemplary embodiments of the present invention, the polarizer may be a relatively small size to increase an optical exposing area of the resin layer which is disposed on the peripheral area of the display panel by the second ultraviolet light.

According to exemplary embodiments of the present invention, a flat panel display device further includes a stiffening tape. The stiffening tape is attached onto the peripheral area of the display panel along a side of the polarizer. The stiffening tape may increase an adhesive bond between the resin layer and the display panel.

According to exemplary embodiments of the present invention, a height of the stiffening tape may be substantially the same as a height of the polarizer.

According to exemplary embodiments of the present invention, a flat panel display device further includes a stiffening tape. The stiffening tape is attached to the peripheral area of the display panel along a side of the polarizer. The stiffening tape prevents an overflow of the resin layer off of the display area of the display panel.

According to exemplary embodiments of the present invention, a height of the stiffening tape may be substantially the same as a height of the resin layer.

According to exemplary embodiments of the present invention, a method of manufacturing a flat panel display device is provided as follows. A black matrix is formed under a window which is combined with a mold. A resin layer is formed on a display panel, which includes a display area and a peripheral area. The display panel has a polarizer which is a relatively small size to increase an optical exposing area of the resin layer on the peripheral area of the display panel. The display panel and the window are laminated with the resin layer which is disposed on the window. The resin layer which is disposed between the display panel and the window is hardened by the application of ultraviolet light.

According to exemplary embodiments of the present invention, the window may have a transmission part through which light passes and a connecting part. The connecting part of the window may be combined with the mold.

According to exemplary embodiments of the present invention, the black matrix may be disposed under the connecting part.

According to exemplary embodiments of the present invention, the polarizer may have a relatively small size to increase an optical exposing area of the resin layer which is disposed on the peripheral area of the display panel.

According to exemplary embodiments of the present invention, a stiffening tape is attached to the peripheral area of the display panel along a side of the polarizer. The stiffening tape may increase the adhesion of the resin layer with the display panel.

According to exemplary embodiments of the present invention, a height of the stiffening tape may be substantially the same as a height of the polarizer.

According to exemplary embodiments of the present invention, a stiffening tape is attached on the peripheral area of the display panel along a side of the polarizer. The stiffening tape prevents an overflow of the resin layer off of the display area of the display panel.

According to exemplary embodiments of the present invention, a height of the stiffening tape may be substantially the same as a height of the resin layer.

According to exemplary embodiments of the present invention, the resin layer which is disposed on the display area of the display panel may be hardened by a portion of the applied ultraviolet light which passes through the transmission part of the window. The resin layer which is disposed on the peripheral area of the display panel may be hardened by a second portion of the applied ultraviolet light which is irradiated from a back side of the display panel.

According to the flat panel display device and the method of manufacturing the same, a hardening ratio of a resin which disposed between a window and a display panel may be increased in a structure of glass in mold (GIM).

### BRIEF DESCRIPTION OF THE DRAWINGS

The above and other features of the present invention will become more apparent by describing in detail exemplary embodiments thereof, with reference to the accompanying drawings in which:

FIG. 1 is a plane view illustrating a flat panel display device according to an exemplary embodiment of the present invention;

FIG. 2 is a cross-sectional view illustrating a flat panel display device illustrated in FIG. 1;

FIG. 3 is a cross-sectional view illustrating a flat panel display device according to an exemplary embodiment of the present invention;

FIG. 4 is a flowchart illustrating a method of manufacturing the flat panel display device illustrated in FIG. 3;

FIG. 5 is a cross-sectional view illustrating a flat panel display device according to an exemplary embodiment of the present invention;

FIG. 6 is a flowchart illustrating a method of manufacturing the flat panel display device illustrated in FIG. 5;

FIG. 7 is a cross-sectional view illustrating a flat panel display device according to an exemplary embodiment of the present invention; and

FIG. 8 is a flowchart illustrating a method of manufacturing the flat panel display device illustrated in FIG. 7.

### DETAILED DESCRIPTION OF THE EMBODIMENTS

Exemplary embodiments of the present invention will be described more fully hereinafter with reference to the accompanying drawings, in which exemplary embodiments are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity. Like numerals may refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present invention.

It will be understood that when an element is referred to as being “connected” or “coupled” to another element, it can be directly connected or coupled to the other element or intervening elements may be present.

FIG. 1 is a plane view illustrating a flat panel display device according to an exemplary embodiment of the present invention.

Referring to FIG. 1, a flat panel display device 100 includes a window 110 and a mold 120.

The window 110 may be disposed on a display area of the flat panel display device 100 on which an image is displayed. The window 110 may include a substrate which may be molded from mixture of a glass fiber and a synthetic resin such as, for example, acryl resin, polycarbonate (PC) and/or polyethylene terephthalate (PET). The window 110 may protect a display panel which is disposed under the window 110.

The mold 120 is formed around the window 110. The mold 120 may be molded from a synthetic resin or by a metal material such as, for example, stainless steel and/or titanium (Ti).

For example, in a structure wherein the window 110 is inserted into the mold 120, a glass in mold (GIM) may be used to decrease a thickness of the flat panel display device and to increase a durability of the flat panel display device.

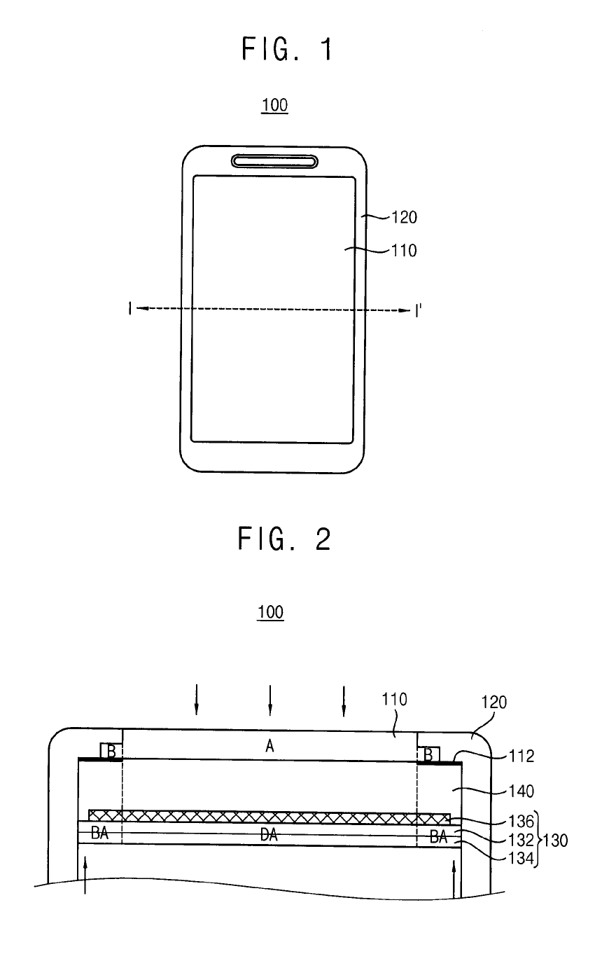

FIG. 2 is a cross-sectional view illustrating a flat panel display device illustrated in FIG. 1.

Referring to FIG. 2, a flat panel display device 100 may include a window 110, a mold 120, a black matrix 112, a display panel 130 and a resin layer 140.

The window 110 may have a glass in mold (GIM) structure wherein the window 110 is inserted into the mold 120. The window 110 may have a transmission part A through which a light passes and a connecting part B which may be combined with the mold 120. The transmission part A and the connecting part B may have a stepped portion to increase an adhesion between the window 110 and the mold 120.

The transmission part A of the window 110 may be disposed on the display area DA on which an image of the display panel 130 may be displayed. The connecting part B of the window 110 may be disposed on the peripheral area BA of the display panel 130.

The mold 120 may be combined with the connecting part B of the window 110. The mold 120 may surround the peripheral area BA of the display panel 130.

The black matrix 112 may be disposed under the connecting part B of the window 110. The black matrix blocks a light which may be leaked out of the mold 120. The black matrix 112 may be formed under the window 110 and on the peripheral area BA of the display panel 130.

The display panel 130 may include a first substrate 132 and a second substrate 134 which is disposed on an opposite side of the first substrate 132 from a polarizer 136.

The display panel 130 may include the display area DA and the peripheral area BA which is the periphery of the display area DA.

The first substrate 132 may be a color filter substrate, and the second substrate 134 may be a thin transistor substrate. The material of the first substrate 132 and the second substrate 135 is not limited thereto. For example, the material of the first substrate 132 and the second substrate 134 may be a transparent glass material or a plastic material.

The polarizer 136 may be disposed on the first substrate 132. The polarizer 136 may change the optical axis from the first substrate 132 and the second substrate 134 or may prevent a diffused reflection on a surface of the display panel 130.

The display panel 130 may include a touch panel on the display panel 130. A light source which may provide a light to the display panel 130 and a driving circuit which may control the display panel 130 may be included on a back side of the display panel 130.

The resin layer 140 may be disposed between the window 110 and the display panel 130. The window 120 and the display panel 130 may be attached by the resin layer 140. The resin layer 140 and the window 110 may protect the display panel 130. An air gap and an impurity which may be inserted between the window 110 and the display panel 130 may be prevented by the resin layer 140. Thus, the resin layer 140 may increase the strength of the flat panel display device.

The resin layer 140 may include an ultraviolet hardening resin, and may be hardened by a light which has an ultraviolet wavelength. For example, the resin layer 140 which is disposed on the display area DA of the display panel 130 may be hardened by a first ultraviolet ray which penetrates the transmission part A of the window 140. The resin layer 140 which is disposed on the peripheral area BA of the display panel 130 may be hardened by a second ultraviolet ray which is radiated from a back side of the display panel 130.

As described, the resin layer 140 may be hardened by the first ultraviolet ray which penetrates the window 110 and by the second ultraviolet ray which is radiated from the back side of the display panel 130. The first ultraviolet ray may be radiated to the resin layer 140 which is on the display area DA of the display panel 130 through the transmission part A of the window 110. The first ultraviolet ray might not be radiated to the resin layer 140 which is on the peripheral area BA of the display panel 130 because the first ultraviolet ray may be blocked by the mold 120 and the black matrix 112. The second ultraviolet ray may be radiated from the back side of the display panel 130. The second ultraviolet ray may be blocked by the polarizer 136 which may be disposed on the top side of the display panel 130. Thus, the second ultraviolet ray may be radiated to the resin layer 140 on which the polarizer is not disposed. The resin layer 140 which is disposed from the end of the polarizer 136 to the start point of the display area DA of the display panel 130 might not be hardened because the first ultraviolet ray and the second ultraviolet ray may not be radiated to this portion of the resin layer 140.

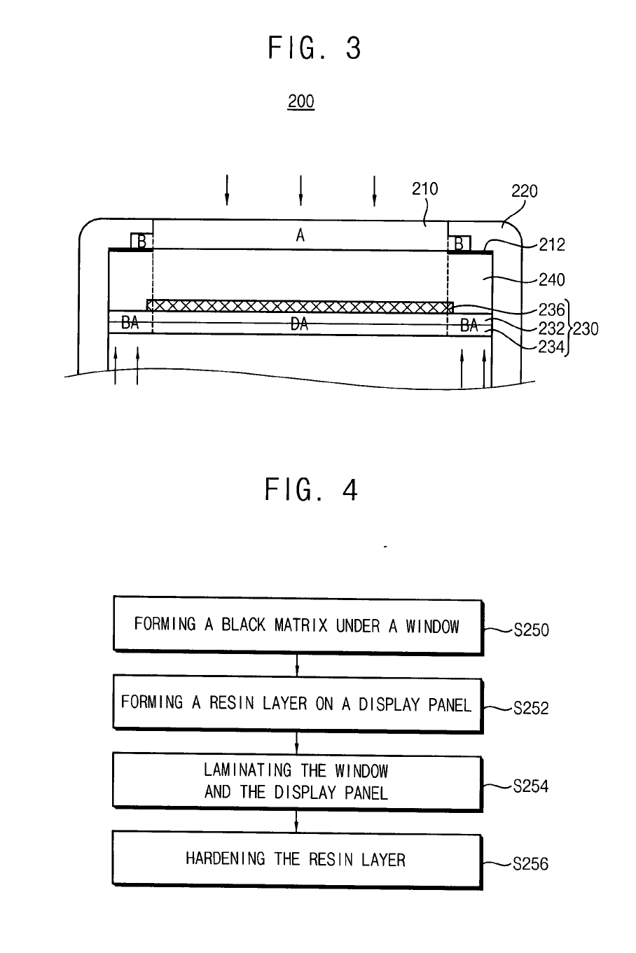

FIG. 3 is a cross-sectional view illustrating a flat panel display device according to an exemplary embodiment of the present invention and FIG. 4 is a flowchart illustrating a method of manufacturing the flat panel display device illustrated in FIG. 3.

Referring to FIG. 3, a flat panel display device 200 may include a window 210, a mold 220, a black matrix 212, a display panel 230 and a resin layer 240.

The display panel 230 may include a first substrate 232 and a second substrate 234 which is disposed opposite to the first substrate 232. The display panel 230 may also include a polarizer 236.

The polarizer 236 has a reduced size compared to the polarizer 136 of FIG. 2 to increase an optical exposing area of the resin layer 240 which may be hardened by a second ultraviolet ray which may be radiated from a back side of the display panel 230. A hardening area of the resin layer 240 which is hardened by the first ultraviolet ray and the second ultraviolet ray may be maximized because an overlap area of the polarizer 236 and the black matrix 222 is reduced. Thus, a hardening ratio of the resin layer 240 may be increased.

For example, if a size of the polarizer 236 is small, the hardening ratio of the resin layer 240 may be increased because the second ultraviolet ray is more widely radiated to the resin layer 240. For example, if a size of the polarizer 236 is smaller than the size of a display area DA, the display area DA of the display panel 230 might not be covered with the polarizer 236. An image might not be fully displayed on the display area DA if the display area DA is not be covered with the polarizer 236. For example, if the size of the polarizer 236 is smaller than the size of the display area DA, a misalignment defect may occur in a lamination process of the polarizer 236 and the display panel 230. Thus, the polarizer 236 may be designed with a desired size corresponding to a size of the display area DA in order to avoid the misalignment defect in the lamination process. The size of the polarizer 236 is not limited to the exemplary embodiments disclosed herein, and may be changed according to, for example, a size of the flat panel display device 200.

The resin layer 240 in which the polarizer 236 is not disposed may be thicker than the resin layer 240 in which the polarizer 236 is disposed to increase an adhesion between the display panel 230 and the window 210.

FIG. 4 is a flowchart illustrating a method of manufacturing the flat panel display device illustrated in FIG. 3.

Referring to FIG. 4, a black matrix 212 may be formed under a window 210 which may be combined with a mold 220 (step S250).

The window 210 may have a transmission part A through which a light may pass and a connecting part B which may be combined with the mold 220. The black matrix 212 may block the light which is leaked out of the mold 220.

A resin layer 240 may be formed on the display panel 230 (step S252).

The display panel 230 may have a display area DA and a peripheral area BA. The display panel 230 may include the polarizer 236 which is downsized to increase the exposing area of the peripheral area BA of the display panel 230.

The display panel 230 may be, for example, one of a liquid crystal display device (LCD), a plasma display panel (PDP) or an organic light emitting diode display (OLED). Various methods of manufacturing the display panel 230 may be implemented according to, for example, the type of the display panel 230.

The resin layer 240 may be formed on the display panel 230, and the resin layer 240 on which the polarizer 236 is not disposed may be formed thicker than the resin layer 240 on which the polarizer 236 is disposed.

The window 210 which may be combined with the mold 220 and the display panel 230 may be laminated (step S254) to each other.

The transmission part A of the window 210 may correspond with the display area DA of the display panel 230, and an image which is displayed on the display area DA of the display panel 230 may be transmitted through the transmission part A of the window 210. The mold 220 may surround the peripheral area BA of the display panel 230, and a light which may be leaked from the peripheral area BA of the display panel 230 may be prevented by the mold 220.

The resin layer 240 may be hardened by, for example, an ultraviolet ray (step S256).

The first ultraviolet ray may be radiated through the transmission part A of the window 210, and the resin layer 240 which may be disposed under the transmission part A of the window 210 may be hardened. The second ultraviolet ray may be radiated from the back side of the display panel 230, and the resin layer 240 which may be disposed on the peripheral area BA of the display panel 230 may be hardened.

As described, the polarizer 236 may be reduced in size to increase an optical exposing area of the resin layer 240 which may be hardened by the second ultraviolet ray which may be radiated from the back side of the display panel 230. The hardening ratio of the resin layer 240 may be increased and an adhesion between the window 210 and display panel 230 may be increased.

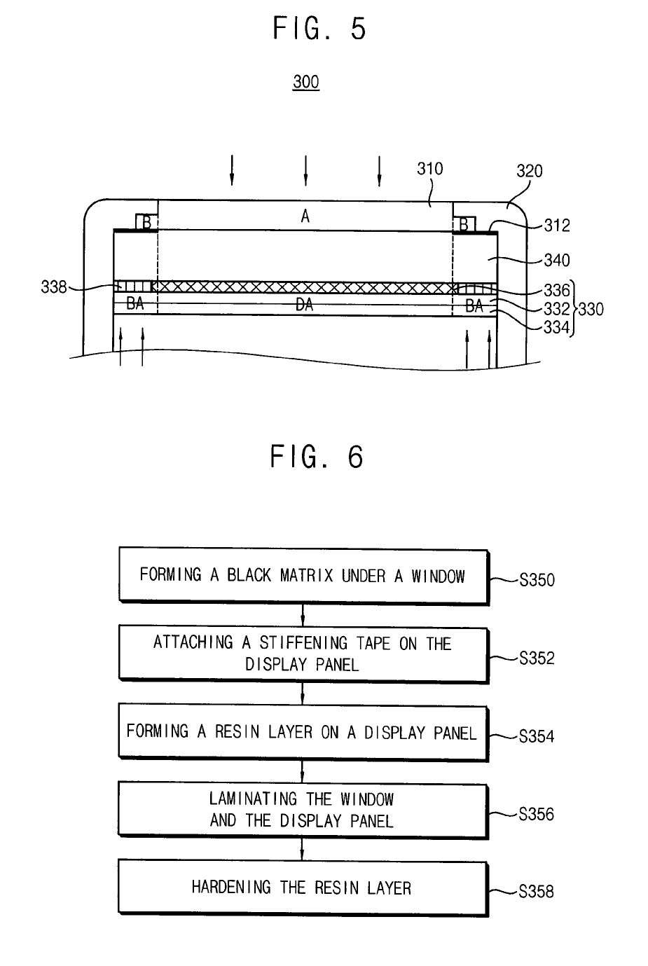

FIG. 5 is a cross-sectional view illustrating a flat panel display device according to an exemplary embodiment of the present invention and FIG. 6 is a flowchart illustrating a method of manufacturing the flat panel display device illustrated in FIG. 5.

Referring to FIG. 5, a flat panel display device 300 may include a window 310, a mold 320, a black matrix 312, a display panel 330 and a resin layer 340.

The display panel 330 may include a first substrate 332 and a second substrate 334 which is disposed opposite to the first substrate 332. The display panel 330 may also include a polarizer 336.

The polarizer 336 which is attached on the display panel 330 may be reduced in size. As described, the polarizer 336 may be, for example, a desired size corresponding to the size of the display area DA while avoiding a misalignment defect in the lamination process. The size of the polarizer 336 is not limited thereto, and may be changed according to the size of the flat panel display device 300, for example.

A stiffening tape 338 may be attached to the first substrate 332 in a region where the polarizer 336 is not disposed. The stiffening tape 338 may be attached to the peripheral area BA of the display panel 330. The stiffening tape 338 may be attached along a side of the polarizer 336 to reinforce a thickness of the portion of the first substrate 332 which is thinner than the another area of the first substrate 332 where the polarizer 336 is disposed on. The stiffening tape 338 which is attached on the display panel 330 may reinforce the thickness of the display panel 330, and a defect which may occur by an external force applied to the display panel 330 may be decreased.

A height of the stiffening tape 338 may be substantially the same as height of the polarizer 336. The reinforced thickness of the display panel 330 may be formed by, for example, a tape, glue or silicon to increase the adhesion of the resin layer 340 with the display panel 330. The stiffening tape 338 may be formed of a transparent material to pass an ultraviolet ray which is radiated from a back side of the display panel 330.

The resin layer 340 may be formed on the display panel 330 on which the polarizer 336 and the stiffening tape 338 are disposed. The resin layer 340 which is in the display area DA of the display panel 330 may be hardened by the first ultraviolet ray which may be radiated through the transmission part A of the window 310. The resin layer 340 which is in the peripheral area BA of the display panel 330 may be hardened by the second ultraviolet ray which may be radiated from the back side of the display panel 330.

Referring to FIG. 6, a black matrix 312 may be formed under a window 310 which may be combined with a mold 320 (step S350).

The window 310 may include a transmission part A through which a light may pass and a connecting part B which may be combined with the mold 320. The black matrix 312 may block a light which is leaked out of the mold 320.

A stiffening tape 338 may be attached to peripheral area BA of the display panel 330 along the side of the polarizer 336 (step S352).

The display panel 330 may have the display area DA and the peripheral area BA. The display panel 330 may include the polarizer 336 which is downsized to increase the exposing area of the peripheral area BA of the display panel 330.

The display panel 330 may be one of, for example, a liquid crystal display device (LCD), a plasma display panel (PDP) and an organic light emitting diode display (OLED). The method of manufacturing the display panel 330 may vary according to, for example, the type of the display panel 330.

The stiffening tape 338 may include a transparent material to pass the second ultraviolet ray which may be radiated from the back side of the display panel 330. The stiffening tape 338 which is formed with the transparent material may increase a hardening ratio of the resin layer 340, and may increase the adhesion between the resin layer 240 and the display panel 330. A height of the stiffening tape 338 may be substantially the same as height of the polarizer 336. The thickness of the display panel 330 which includes the polarizer 336 and the stiffening tape 338 may be the same throughout the display panel 330. Thus, the durability of the flat panel display device may be increased.

The resin layer 340 may be formed on the display panel 330 (step S354).

The resin layer 340 may be formed on the display panel 330 and may be formed at a uniform thickness because the stiffening tape 338 is attached along the polarizer 336.

The window 310 which may be combined with the mold 320 and the display panel 330 may be laminated (step S356).

The transmission part A of the window 310 may correspond with the display area DA of the display panel 330, and an image which is displayed on the display area DA of the display panel 330 may be transmitted through the transmission part A of the window 310. The mold 320 may surround the peripheral area BA of the display panel 330, and a light which may be leaked from the peripheral area BA of the display panel 330 may be prevented by the mold 320.

The resin layer 340 may be hardened by the ultraviolet rays (step S358).

The resin layer 340 may be hardened by the first ultraviolet ray which is radiated through the transmission part A and the second ultraviolet ray which may be radiated from the back side of the panel display 330.

As described, the stiffening tape 338, which may include a transparent material, may be attached to the first substrate panel in which the polarizer 336 is not disposed. Thus, the hardening ratio of the resin layer 340 may be increased. Further, the stiffening tape 338 which has the same thickness as the polarizer 336 may increases the adhesion between the window 310 and the display panel 330, and increases the durability of the display panel.

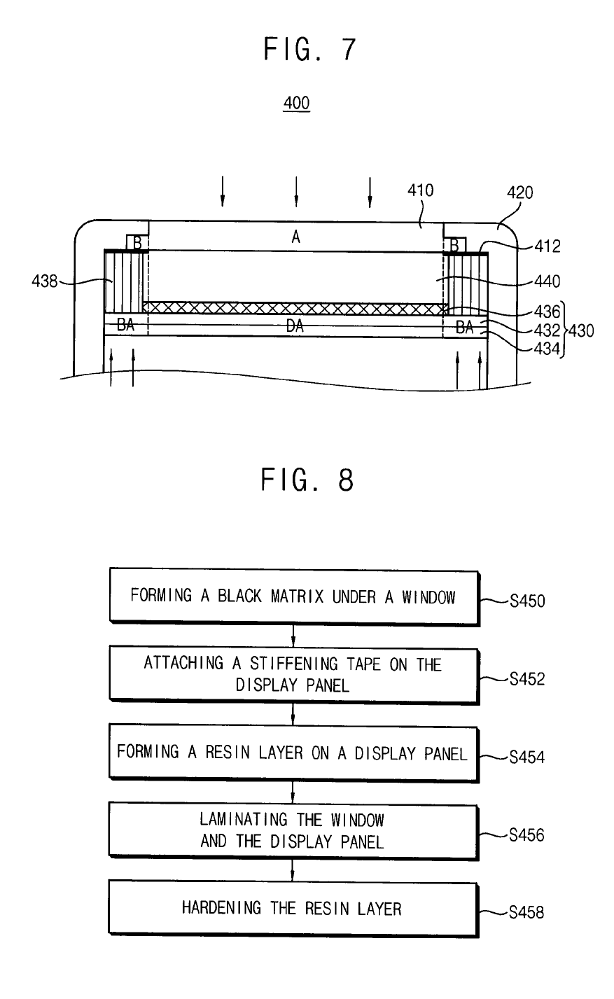

FIG. 7 is a cross-sectional view illustrating a flat panel display device according to an exemplary embodiment of the present invention and FIG. 8 is a flowchart illustrating a method of manufacturing the flat panel display device illustrated in FIG. 7.

Referring to FIG. 7, a flat panel display device 400 may include a window 410, a mold 420, a black matrix 412, a display 430 and a resin layer 440.

The display panel 430 may include a first substrate 432 and a second substrate 434 which is disposed on an opposite side of the first substrate 432 from a polarizer 436.

The polarizer 436 which is attached to the display panel 430 may be reduced in size compared with the polarizer 136 of FIG. 1. As described, the polarizer 436 may be a desired size according to, for example, a size of the display area DA in order to avoid a misalignment defect in the lamination process. The size of the polarizer 436 is not limited thereto, and may be changed, for example, by the size of the flat panel display device 400.

A stiffening tape 438 may be attached to the first substrate 432 in a region of the first substrate 432 where the polarizer 436 is not disposed. The stiffening tape 438 may be attached to the peripheral area BA of the display panel 430 along a side of the polarizer 436 to prevent an overflow of the resin layer 440 which is liquid off of the display area DA of the display panel 430. A defect occurred by the overflow of the resin layer 440 may be decreased by the stiffening tape 438.

A height of the stiffening tape 438 may be substantially the same as a height of the resin layer 440 disposed on the display area DA of the display panel 430. The stiffening tape 438 may include tape, glue or silicon to increase the adhesion of the resin layer 440 with the display panel 430. The stiffening tape 438 may be formed in the peripheral area BA of the display panel 430, and may prevent the overflow of the resin layer 440 off of the display area DA of the display panel 430.

The resin layer 440 which is disposed in the display area DA of the display panel 430 may be hardened by the first ultraviolet ray which may be radiated through the window 410.

Referring to FIG. 8, a black matrix 412 may be formed under a window 410 which may be combined with a mold 420 (step S450).

The window 410 may include a transmission part A through which a light may pass and a connecting part B which may be combined with the mold 420. The black matrix 412 may block a light which is leaked out of the mold 420.

A stiffening tape 438 may be attached to peripheral area BA of the display panel 430 along the side of the polarizer 436 (step S452).

The display panel 430 may include the display area DA and the peripheral area BA. The display panel 430 may include the polarizer 436 which is reduced in size to increase the exposing area of the peripheral area BA of the display panel 430.

The display panel may be one of, for example, a liquid crystal display device (LCD), a plasma display panel (PDP) and an organic light emitting diode display (OLED). Various methods of manufacturing the display panel 430 may be implemented according to, for example, the type of the display panel 430.

A height of the stiffening tape 438 may be the same as a height of the resin layer 440 to prevent the overflow of the resin layer 440 off of the display panel 430 and to decrease the defect that may occur by excess resin of the resin layer 440. The stiffening tape 438 may increase the adhesion between the display panel 430 and the window 410.

The resin layer 440 may be formed on the display panel 430 (step S454).

The resin layer 440 may be formed on the display area DA of the display panel 430. The overflow of excess resin off of the resin layer 440 may be prevented by the stiffening tape 438 which may be attached to the peripheral area BA of the display panel 430 along the polarizer 436 at the same height as the resin layer 440.

The window 410 which may be combined with the mold 420 and the display panel 430 may be laminated (step S456).

The transmission part A of the window 410 may correspond with the display area DA of the display panel 430. An image which may be displayed on the display area DA of the display panel 430 may be transmitted through the transmission part A of the window 410. The mold 420 may surround the peripheral area BA of the display panel 430, and a light which may be leaked from the peripheral area BA of the display panel 430 may be prevented by the mold 420.

The resin layer 440 may be hardened by the ultraviolet rays (step S458).

The resin layer 440 may be hardened by the first ultraviolet ray which may be radiated through the transmission part A. The resin layer 440 may be disposed in the display area DA of the display panel 430 because the stiffening tape 438 which may have the same height with the resin layer 440 may be formed in the peripheral area BA of the display panel 430. Thus, the first ultraviolet ray which is radiated through the transmission part A may harden the resin layer 440 without the second ultraviolet ray which may be radiated from a back side of the display panel 430.

As described, the stiffening tape 438, which may include a transparent material, may be attached to the first substrate panel 432 in a region where the polarizer 436 is not disposed. Thus, the resin layer 440 may only be disposed in the display area DA of the display panel 430, and the resin layer 440 may be hardened by the first ultraviolet ray which is radiated through the window 410. The stiffening tape 438 may prevent the overflow of excess resin off of the resin layer 440, and the defect that may occur by excess resin overflowing off of the resin layer 440 may be decreased. The adhesion of the window 410 with the display panel 430 may be increased.

Exemplary embodiments of the present invention may be applied to, for example, any portable device that includes a cellular phone, a smart-phone, a laptop computer, a tablet PC, a digital multimedia broadcast terminal, a personal digital assistant, portable multimedia player, e-book or navigation device. The present invention may be applied to any fixable device including, for example, a digital TV and/or a desktop computer.

While the present invention has been particularly shown and described with reference to exemplary embodiments thereof, it will be understood by those of ordinary skill in the art that various changes in form and detail may be made therein without departing from the spirit and scope of the present invention.

What is claimed is:

1. A flat panel display device comprising:
a window comprising a transmission part configured to transmit light therethrough and a connecting part;
a mold coupled to the connecting part of the window;
a black matrix disposed under the connecting part of the window, the black matrix configured to block light which is leaked from the mold;
a display panel disposed under the window, the display panel comprising a first substrate, a second substrate which is disposed opposite to the first substrate, and a polarizer which is disposed on the first substrate; and
a resin layer disposed between the window and the display panel, wherein the resin layer is hardened by ultraviolet light.

2. The flat panel display device of claim 1, wherein the display panel comprises a display area on which an image is displayed and a peripheral area which surrounds the display area.

3. The flat panel display device of claim 2, wherein the transmission part of the window is disposed on the display area of the display panel,
wherein the connecting part of the window is disposed on the peripheral area of the display panel, and
wherein the transmission part and the connecting part of the window each have a stepped portion.

4. The flat panel display device of claim 2, wherein the mold surrounds the peripheral area of the display panel.

5. The flat panel display device of claim 2, wherein the black matrix is
disposed under the connecting part of the window, and
wherein the black matrix is disposed on the peripheral area of the display panel.

6. The flat panel display device of claim 2, wherein the resin layer, which is disposed on the display area of the display panel, is hardened by a first ultraviolet light which passes through the transmission part of the window, and
wherein the resin layer which is disposed on the peripheral area of the display panel is hardened by a second ultraviolet light which is radiated from a back side of the display panel.

7. The flat panel display device of claim 2, wherein the polarizer is configured to be relatively small in size to increase an optical exposing area of the resin layer which is disposed on the peripheral area of the display panel by the second ultraviolet light.

8. The flat panel display device of claim 2, further comprising:
a stiffening tape attached to the peripheral area of the display panel along a side of the polarizer, the stiffening tape configured to increase an adhesion between the resin layer and the display panel.

9. The flat panel display device of claim 8, wherein a height of the stiffening tape is substantially the same as a height of the polarizer.

10. The flat panel display device of claim 2, further comprising:
a stiffening tape attached to the peripheral area of the display panel along a side of the polarizer, the stiffening tape configured to prevent an overflow of the resin layer off of the display area of the display panel.

11. The flat panel display device of claim 10, wherein a height of the stiffening tape is substantially the same as a height of the resin layer.

12. A method of manufacturing a flat panel display device, the method comprising:
forming a black matrix under a window which is coupled to a mold;
forming a resin layer on a display panel, which includes a display area and a peripheral area, the display panel having a polarizer which has a relatively small size to increase an optical exposing area of the resin layer on the peripheral area of the display panel;
laminating the display panel and the window to each other using the resin layer; and
hardening the resin layer which is disposed between the display panel and the window, by the application of ultraviolet light thereto.

13. The method of claim 12, wherein the window comprises a transmission part, through which light passes, and a connecting part,
wherein the connecting part of the window is coupled to the mold.

14. The method of claim 12, wherein the black matrix is formed under the connecting part.

15. The method of claim 12, wherein the polarizer is configured to have a relatively small size to increase an optical exposing area of the resin layer which is disposed on the peripheral area of the display panel.

16. The method of claim 12, further comprising:
attaching a stiffening tape to the peripheral area of the display panel along a side of the polarizer, the stiffening tape configured to increase an adhesion of the resin layer with the display panel.

17. The method of claim 16, wherein a height of the stiffening tape is substantially the same as a height of the polarizer.

18. The method of claim 12, further comprising:
attaching a stiffening tape on the peripheral area of the display panel along a side of the polarizer, the stiffening tape configured to prevent an overflow of the resin layer off of the display area of the display panel.

19. The method of claim 18, wherein a height of the stiffening tape is substantially the same as a height of the resin layer.

20. The method of claim 12, wherein the resin layer which is disposed on the display area of the display panel is hardened by a first portion of the applied ultraviolet light which passes through the transmission part of the window, and
wherein the resin layer which is disposed on the peripheral area of the display panel is hardened by a second portion of the applied ultraviolet light which is radiated from a back side of the display panel.
